(19) United States
(12) Patent Application Publication
(10) Pub. No.: US 2002/0067603 A1
(43) Pub. Date: Jun. 6, 2002

(54) Method and apparatus employing fluorescence for the detection of coated regions on a monofilament braid

(76) Inventors: Timothy Driscoll, Pawtucket, RI (US); John A. Moon, Wallingford, CT (US); William Goltsos, Warren, RI (US); Nabil M. Lawandy, North Kingstown, RI (US)

Correspondence Address: HARRINGTON & SMITH, LLP, 1809 BLACK ROCK TURNPIKE, FAIRFIELD, CT, 06432, US

(21) Appl. No.: 09/916,384

(22) Filed: Jul. 27, 2001

Related U.S. Application Data
(60) Provisional application No. 60/222,411, filed on Aug. 2, 2000.

(51) Int. Cl. G03B 15/02

(52) U.S. Cl. 362/5; 362/84; 209/576

(57) ABSTRACT

Disclosed is a system and method for determining a location of a coated region on a braided structure. The system includes at least one light source for illuminating the braided structure and at least one detector for detecting an optical contrast between the braided structure and the coated region. A data processor may be provided for determining the location of the coated region based on the detected optical contrast. The light source may be an ultraviolet light source, and the detector detects a fluorescent emission from at least one strand or filament, e.g. a monofilament, that forms a part of the braided structure. More specifically, the detector detects at least one of a reduction or an increase in a fluorescent emission from the least one filament, where the reduction and/or the increase is due to the presence of the coated region that overlies the at least one filament. The detector may be coupled to a data processor for determining an average fluorescence intensity collected by a plurality of line scans made parallel to the braided structure. In another embodiment the detector detects a difference in reflection between light reflecting from the braided structure and light reflecting from the coated region, while in a further embodiment the detector detects a difference in transmission between light passing through the braided structure and any light that passes through the coated region.

### CLAIM OF PRIORITY FROM A COPENDING PROVISIONAL PATENT APPLICATION

This patent application claims priority under 35 U.S.C. 119(e) from Provisional Patent Application No.: 60/222,411, filed Aug. 2, 2000, incorporated by reference herein in its entirety.

### TECHNICAL FIELD

These teachings relate generally to optically-based detection systems and, more specifically, to systems and methods that operate on braided or woven structures, such as monofilament braided structures that form sheaths, during the processing thereof and during the manufacture of components made from portions of the structures, such as protective sheaths for wiring, piping and mechanical components.

### BACKGROUND

Monofilament strands are frequently woven or braided into sleeves in order to create protective structures. These sleeves may be designed to contain electrical wires, piping, hoses, or mechanical assemblies. The sleeve may serve to protect the contained assembly or component from heat, vibration, abrasion, dirt, oil, moisture, acids, caustics, or solvents. The protective sleeves are frequently found in environments such as internal combustion engines, aircraft fuselages, and within machinery.

During the braid or sheath manufacturing process the structures are commonly manufactured in one continuous length. In order to cut the braid into shorter lengths, without fraying of the ends, an adhesive or an epoxy may be applied to the structure at the locations where cuts are desired, thereby providing coated regions along the length of the braided structure. During an automated manufacturing process the proper cutting of the braided structure relies upon the accurate determination of the location of the coated regions. However, there may be variations in the size and placement of the coated regions, making the automatic cutting of the braided structure at predetermined locations or lengths, as it passes through a cutting machine or stage, less than an optimum approach.

It can be appreciated that it would be desirable to provide a non-contact and accurate methodology for locating the coated regions on the moving braided structure so that the braided structure can be cut at the desired location(s).

### SUMMARY

The foregoing and other problems are overcome by methods and apparatus in accordance with embodiments of these teachings.

A system is disclosed for determining a location of a coated region on a braided structure, as is a method for determining the location of the coated region. The system includes at least one light source for illuminating the braided structure and at least one detector for detecting an optical contrast between the braided structure and the coated region. A data processor may be provided for determining the location of the coated region based on the detected optical contrast. The light source may be an ultraviolet light source, and the detector detects a fluorescent emission from at least one strand or filament, e.g. a monofilament, that forms a part of the braided structure. More specifically, the detector detects at least one of a reduction or an increase in a fluorescent emission from the least one filament, where the reduction and/or the increase is due to the presence of the coated region that overlies the at least one filament.

The detector may be coupled to a data processor for determining an average fluorescence intensity collected by a plurality of line scans made parallel to the braided structure. The detector may include an area array having rows and columns of radiation detector elements, such as a CCD imager.

In another embodiment the detector detects a difference in reflection between light reflecting from the braided structure and light reflecting from the coated region, while in a further embodiment the detector detects a difference in transmission between light passing through the braided structure and any light that passes through the coated region.

The system further includes apparatus for performing at least one desired operation within the coated region in response to determining the location of the coated region. In the preferred embodiment the apparatus includes a cutter for cutting through the braided structure within the coated region, where the coated region is provided so as to inhibit the unraveling of the cut ends of the braided structure. The apparatus may also include some mechanism, such as an ink jet printer or a laser, for placing indicia within the coated region.

These teachings also encompass a braided structure made from a plurality of filaments, monofilaments or strands that are woven or braided together for forming a hollow sheath-like structure. The braided structure has a length along which are disposed a plurality of coated regions. In one embodiment at least one of the strands is provided so as to emit a characteristic fluorescent emission in response to excitation light for use in detecting the locations of the plurality of coated regions, while in another embodiment the plurality of coated regions are formed of a material selected for emitting a characteristic fluorescent emission in response to excitation light for use in detecting the locations of the plurality of coated regions.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is a block diagram of an optically-based braid cutting system in accordance with these teachings.

FIG. 2 shows a representation of a fluorescence image captured at the edge of the coated region on a monofilament braid, showing that the fluorescence from the monofilament strands on the left is completely extinguished by the coated region.

FIG. 3 is a graph that plots the average fluorescence intensity collected by 21 line scans made parallel to the braid depicted in FIG. 1 by the optical system of FIG. 1.

FIG. 4 depicts an embodiment wherein the optical system relies upon detecting variations in surface reflectivity of the braided structure for detecting the location of the coated region.

FIG. 5 depicts an embodiment wherein the optical system relies upon detecting varying amounts of light transmission through the braided structure for detecting the location of the coated region.

### DETAILED DESCRIPTION OF THE PREFERRED EMBODIMENTS

As employed herein an optical contrast may indicated by a presence or an absence (complete or partial) of a fluorescent emission, the presence or absence (complete or partial) of reflected light, the presence or absence (complete or partial) of transmitted light, the presence or absence (complete or partial) of a specific wavelength or wavelengths or, more generally, any characteristic of light, such as intensity or wavelength, that is detectable by a suitable optical detector, and that can be shown to differ from one spatial location to another.

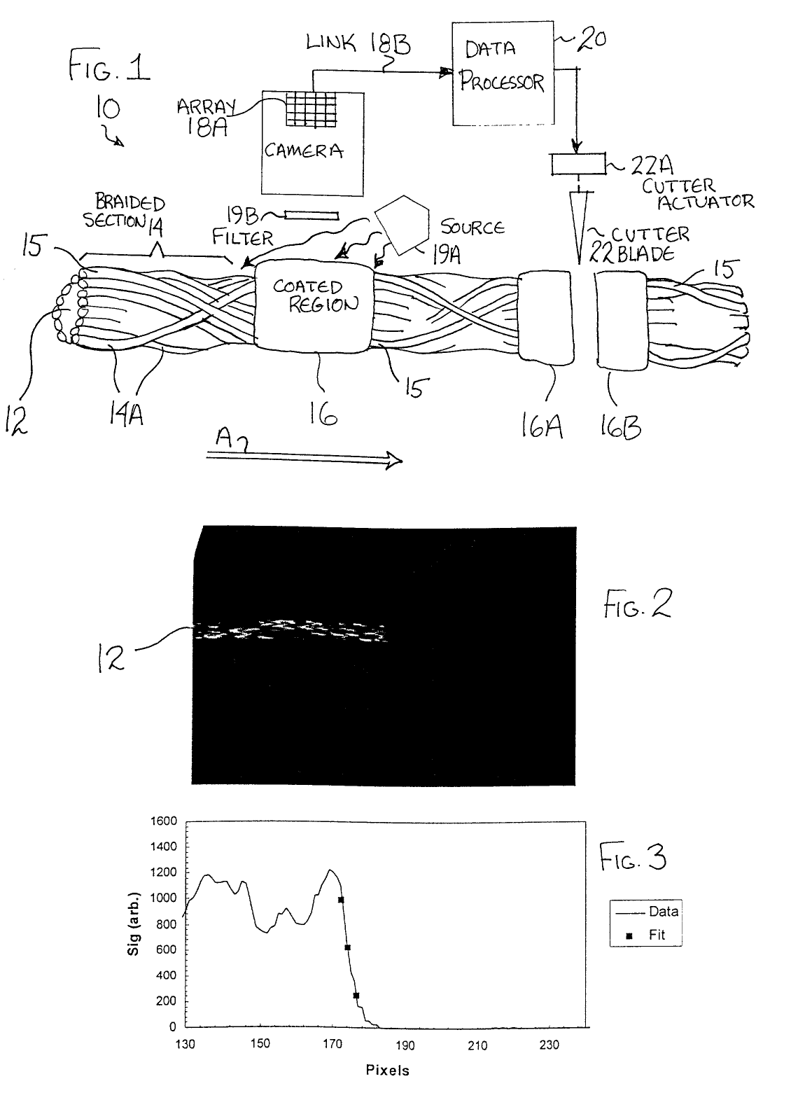

FIG. 1 is a block diagram of an optically-based braid cutting system 10 in accordance with a presently preferred embodiment of these teachings. The system 10 is assumed to operate on a braided structure 12 that includes a continuous woven or braided section 14 that is periodically coated along its length with an adhesive or an epoxy or some other similar material for forming coated regions 16, a purpose of which is to prevent the unraveling of the braided section 14 after the braided section is cut. A typical length of the coated region 16 may be about an inch, and the distance between coated regions 16 is a function of the intended application for the braided sections 14. As an example, for an application where the braided section 14 is intended to cover a wiring harness in an aircraft or automotive application, the distance between coated regions 16 may range from inches to tens of feet or even longer.

The braided section 14 is comprised of a plurality of strands or filaments 14A that may be a monofilament polymeric material such as nylon or polyester, and may be formed using a conventional type of braiding machine. There may be any suitable number of filaments 14A in the braided section 14, such as 32 filaments. The braided structure 12 is sized according to its intended application, and may have a diameter from fractions of inch to some number of inches.

In accordance with an aspect of these teachings the system 10 includes a camera 18, such as a solid state camera that includes a CDD imager array 18A. The imager array 18A may be an area (2-D) array having rows and columns of pixels, or the imager array 18A could be a linear (1-D) array having a single row of pixels. An output of the camera 18 is coupled via link 18B to an input of a suitable data processor 20, such as a personal computer (PC), a workstation, a portable computer, or a computer, microprocessor or microcontroller embedded within some device or system, or the data processor 20 could be embodied in a mainframe computer. The data processor 20 may be locally situated, or it may be located at some at distance from the camera 18, and the link 18B may include a data communications network, including the internet, and/or a wireless (e.g., RF or IR) link.

It is assumed for the purposes of this specification that it is desired to cut the braided section 14 within the coated regions 16, thereby forming cut ends 16A, 16B that are located within one of the coated regions 16.

It is thus also assumed for the purposes of this specification that the system 10 includes some suitable mechanism for severing the braided structure 12, such as a fixed or rotating cutting blade 22 having an actuator 22A that is controlled by the data processor 20. In other embodiments a laser could be used to cut the braided structure 12.

In still other embodiments a cutting operation may not be performed, but instead some other type of operation is performed wherein it is desired to first accurately locate the coated regions 16. As but one example, instead of cutting the braided structure 12 it may be desirable to instead imprint some type of indicia or information onto the coated regions, such as a part number, a manufacturer's logo, and/or an indication of length. The printing device could be an ink jet printer or a laser-based writing device. In this case it can be appreciated that it is also required to accurately detect the location of the coated regions 16. It is also within the scope of these teachings to place indicia onto the coated regions 16 prior to cutting them.

It is also assumed that some relative motion exists between the braided structure 12 and the camera 18/cutter 22, as indicated by the arrow A in FIG. 1. Typically the braided structure 12 is in motion with some velocity relative to the fixed camera 18 and cutter 22, although in other embodiments the reverse could be true.

In a presently preferred embodiment of these teachings at least one, and preferably a plurality of visually non apparent, fluorescent monofilament strands 15 are incorporated during manufacture into the braided structure 12. These monofilament strand(s) 15 may be deemed non apparent by selecting a monofilament with a color close to the other strands 14A in the braided structure 12 (e.g., white), or by using a transparent monofilament material such as a naturally clear nylon or polyester. It is not, however, a requirement that the fluorescent monofilament strands 15 be visually non apparent relative to the other strands or filaments 14A.

A fluorescent material that is coated onto or incorporated into the monofilament strands 15, if the strands are not normally fluorescent, is preferably selected so that its excitation and emission wavelengths are absorbed to some degree by the material of the coated regions 16. By using a camera system 18 which uses an illumination source 19A matched to an absorption band of the fluorescent material, the location of the edge of the coated region 16 can be determined with a high signal to noise ratio by measuring the fluorescence from the monofilament strand(s) 15. The camera system 18 is preferably made “blind” to the excitation wavelength of the source 19A, and an optical passband filter 19B may be provided to accept only the emission wavelength in order to improve contrast and increase the speed of image processing. In addition, the situation could be reversed such that fluorescence (either natural or from an additive) of the coated region 16 is used to discern the location of the coated region 16.

As one suitable example, the light source 19A may be a pulsed or continuous UV excitation source operating in a wavelength range that includes about 300 nm, more preferably about 370 nm, the fluorescent material that comprises the monofilament strand(s) 15 could comprise a member of the Stilbene family that is visually clear or uncolored but that fluoresces in the wavelength range of about 325 nm to about 450 nm (e.g., Stilbene 420), and the filter 19B then is selected to exclude 370 nm excitation UV light and to pass the emission light from the monofilament strand(s) 15. This example is not to be construed in a limiting sense upon the practice of these teachings, as other suitable fluorescent materials may be employed, as may other excitation wavelengths and filter passbands. For example, certain Coumarin and Rhodamine dyes could be used as well.

The algorithm for detecting a fluorescent monofilament strand 15 in relation to an optically thick coating 16 accurately distinguishes the border between the braided section 14 and the coated region 16. Assuming that the braided structure 12 is constructed entirely using the fluorescent monofilament strands 15, a relatively simple line scan of the fluorescent emission intensity along the braided structure 12 is sufficient to locate the point of demarcation between the braided section 14 and the coated region 16. However, if only some fraction of the monofilament strands 15 are fluorescent (e.g., eight out of 32), the algorithm cannot rely upon a simple measurement along one line of pixels of the camera's CCD array 18A, as a particular strand 15, due to the braiding, will typically pass in and out of view of the camera 18.

Preferably, detection of the coated regions 16 is assured by either incorporating several monofilament strands 15, several cameras 18, or both, in order to provide visual coverage of the entire perimeter of the braided structure 12. For example, if eight fluorescent monofilament strands 15 are used with 24 non-fluorescent strands 14A, a single camera 18 will always detect at least two monofilament strands 15.

By taking a series of line scans parallel to the length of the braided structure 12 by reading signal out of multiple rows of the CCD imager 18A, and in such a manner as to cover the profile of the braid, an average fluorescence intensity along the length of the braided structure 12 may be obtained. Judicious selection of an intensity threshold results in an accurate detection of the location of the coated region 16. For example, as the average fluorescence intensity along the braid length falls off, the edge of the coated region may be determined by the algorithm executed by the processor 20 to be the 20% intensity point.

FIG. 2 depicts an example of a fluorescent image seen by the camera system 18, while FIG. 3 graphs the average fluorescence intensity collected simultaneously by 21 line scans of the CCD imager 18A. The scans in this example were made parallel to the length of the braided structure 12, and traversed the visible perimeter. The rapid fall-off in the average fluorescent intensity emitted by the monofilament strands 15 is readily apparent, and is indicative of the edge of the coated region 16.

Upon detecting the edge of the coated region 16 the algorithm executed by the data processor 20 is enabled to send a command to the cutter actuator 22A to cut the braided structure 12. It may be assumed that the relative velocity of the braided structure 12 with respect to the cutter blade 22 is known, as is the response time of the cutter actuator 22A, and the command may be delayed for a suitable period of time to place the cut at a desired location within the coated region 16. In another embodiment it may be desirable to detect both the leading edge (declining average flourescent intensity) and the trailing edge (increasing average flourescent intensity) of the coated region 16, and to then issue the cut command to more precisely position the cut within the coated region 16. This later embodiment may be particularly desirable where the length of the coated regions 16 varies from one to another. These same considerations apply for the case where some operation other than cutting, such as printing, is be performed within the coated region 16.

In conclusion, a high contrast, fluorescence-based detection method has been outlined to aid in the accurate determination of the presence of a coating or protective layer, i.e., the coated region 16, on a braided sleeve that is to be cut from the braided structure 12. This information may be used to determine the length of the part and/or to locate the coated region 16 for cutting or other purposes.

Other approaches than the high contrast, fluorescence-based detection method may also be employed in accordance with these teachings. For example, one may employ a fluorescent coating region 16 on a non-fluorescent braid 14, or one may employ a coating region that fluoresces at a first wavelength on a braid 14 that fluoresces at a second wavelength, and to then also employ one or more camera assemblies 18 that are responsive to both of the emission wavelengths.

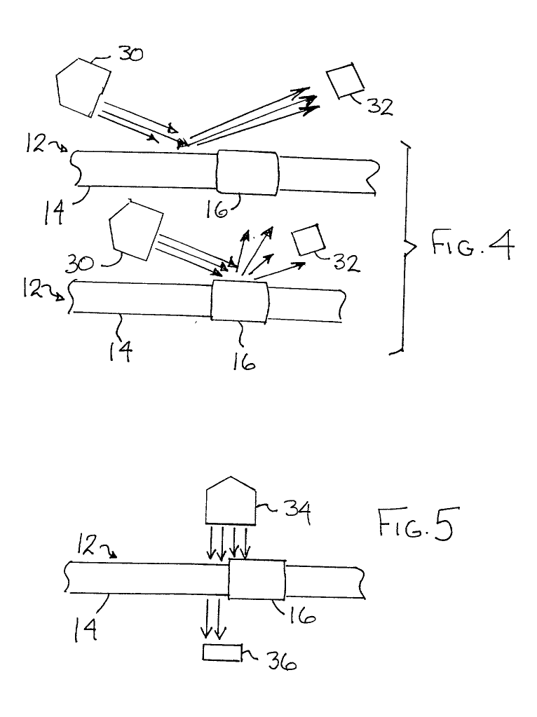

In a further embodiment the optical system may rely instead upon variations in the surface reflectivity for detection of the coated region 16. For example, and referring to FIG. 4, if the monofilament braided section 14 has a glossy appearance while the coated region 16 has a matte or less reflective finish, observing changes in the specular reflection from a collimated light source 30 with one or more light detectors 32, such as photodiode(s) or CCD imager array(s), the algorithm executed by the data processor 20 is enabled to distinguish between the coated sections 16 and the uncoated sections 14. In general, the specular reflection from the glossy braided region 14 exhibits a narrower diffraction angle than a reflected spot from a matte finish applied to the coated regions 16. By placing the light detector(s) 32 at one or more locations where they are best positioned to receive the reflected light from the braided section 14, the reduction in intensity due to the increased scattering of the light from the coated regions 16 is detectable and indicative of the presence of the coated region 16 in the path of the beam from the collimated source 30.

Since the coating material of the coated regions 16 also serves to increase the opacity of the braided structure at those locations, in the further embodiment shown in FIG. 5 an optical measurement is used to locate the coated regions 16 by measuring light transmission through the braided structure 12 between a light source 34 and a light detector 36.

In a somewhat similar fashion, the presence of the coated region 16 may be identified by ultrasonics, where the coated region 16 is assumed to be less transparent to ultrasonic waves. However, this approach may require that physical contact be made to the braided structure 12.

In a further embodiment, and assuming that there exists an optical contrast (e.g. colored monofilament strand(s) 15 and a black coating material in the coated regions 16), the camera system 18 may be used to image in the visible regime and to then detect the coated regions 16 by employing some type of image processing algorithm. For braided structures 12 that lack a discernible color contrast (e.g., a black coating on a black monofilament braid or a white coating on a white monofilament braid), one or more of the other approaches described above are preferably employed.

While described above in the context of a CCD or similar type of area array camera 18, it should be appreciated that the teachings herein may be practiced as well by using one or more discrete photodetectors provided with suitable filter(s), and then using threshold detection to locate the edge(s) of the coated regions 16.

Thus, while these teachings have been particularly shown and described with respect to preferred embodiments thereof, it will be understood by those skilled in the art that changes in form and details may be made therein without departing from the scope and spirit of these teachings.

What is claimed is:

1. A method for determining a location of a coated region on a braided structure, comprising:
illuminating the braided structure with light; and
operating a detector for detecting an optical contrast between the braided structure and the coated region for determining the location of the coated region.

2. A method as in claim 1, where the step of illuminating operates an ultraviolet light source, and where the step of detecting detects a fluorescent emission from at least one filament that forms a part of the braided structure.

3. A method as in claim 1, where the step of illuminating operates an ultraviolet light source, and where the step of detecting detects a reduction in a fluorescent emission from at least one filament that forms a part of the braided structure, the reduction being due to the presence of the coated region that overlies the at least one filament.

4. A method as in claim 1, where the step of illuminating operates a light source, and where the step of detecting detects a difference in reflection between light reflecting from the braided structure and light reflecting from the coated region.

5. A method as in claim 1, where the step of illuminating operates a light source, and where the step of detecting detects a difference in transmission between light passing through the braided structure and light passing through the coated region.

6. A method as in claim 1, and further comprising performing at least one desired operation within the coated region in response to determining the location of the coated region.

7. A method as in claim 6, wherein the desired operation is cutting.

8. A method as in claim 6, wherein the desired operation is placing indicia within the coated region.

9. A method as in claim 1, where the step of illuminating operates an ultraviolet light source, and where the step of detecting detects an increase in a fluorescent emission from at least one filament that forms a part of the braided structure, the increase being due to the presence of the coated region that overlies the at least one filament.

10. A method as in claim 1, where the step of detecting detects an average fluorescence intensity collected by a plurality of line scans made parallel to the braided structure.

11. A system for determining a location of a coated region on a braided structure, comprising:
at least one light source for illuminating the braided structure; and
at least one detector for detecting an optical contrast between the braided structure and the coated region for determining the location of the coated region.

12. A system as in claim 11, where the light source is comprised of an ultraviolet light source, and where the detector detects a fluorescent emission from at least one filament that forms a part of the braided structure.

13. A system as in claim 11, where the light source is comprised of an ultraviolet light source, and where the detector detects a reduction in a fluorescent emission from at least one filament that forms a part of the braided structure, the reduction being due to the presence of the coated region that overlies the at least one filament.

14. A system as in claim 11, where the detector detects a difference in reflection between light reflecting from the braided structure and light reflecting from the coated region.

15. A system as in claim 11, where the detector detects a difference in transmission between light passing through the braided structure and light passing through the coated region.

16. A system as in claim 11, and further comprising apparatus for performing at least one desired operation within the coated region in response to determining the location of the coated region.

17. A system as in claim 16, wherein the apparatus is comprised of a cutter for cutting through the braided structure within the coated region.

18. A system as in claim 16, wherein the apparatus is comprised of means for placing indicia within the coated region.

19. A system as in claim 11, where the light source is comprised of an ultraviolet light source, and where the detector detects an increase in a fluorescent emission from at least one filament that forms a part of the braided structure, the increase being due to the presence of the coated region that overlies the at least one filament.

20. A system as in claim 11, where the detector is coupled to a data processor for determining an average fluorescence intensity collected by a plurality of line scans made parallel to the braided structure.

21. A system as in claim 11, where the detector is comprised of an area array having rows and columns of radiation detector elements.

22. A braided structure comprised of a plurality of strands that are braided together for forming a sheath, said braided structure having a length along which are disposed a plurality of coated regions, wherein at least one of said strands is provided so as to emit a characteristic fluorescent emission in response to excitation light for use in detecting the locations of said plurality of coated regions.

23. A braided structure comprised of a plurality of strands that are braided together for forming a sheath, said braided structure having a length along which are disposed a plurality of coated regions, wherein said plurality of coated regions are comprised of a material selected for emitting a characteristic fluorescent emission in response to excitation light for use in detecting the locations of said plurality of coated regions.
